(19) United States
(12) Patent Application Publication
(10) Pub. No.: US 2008/0127896 A1
(43) Pub. Date: Jun. 5, 2008

(54) Method, Computer Program Product and Arrangement for Controlling the Milking by a Milking Machine

(76) Inventors: Tobjorn Petterson, Gnesta (SE); Bohao Liao, Sollentuna (SE)

Correspondence Address: HARNESS, DICKEY & PIERCE, P.L.C., P.O. BOX 8910, RESTON, VA, 20195, US

(21) Appl. No.: 11/791,525

(22) PCT Filed: Dec. 13, 2005
(86) PCT No.: PCT/SE2005/001902

§ 371 Date: May 24, 2007

(30) Foreign Application Priority Data
Dec. 20, 2004 (SE) 0403089-6

(51) Int. Cl. A01J 5/007

(52) U.S. Cl. 119/14.02; 119/14.08; 119/14.03

(57) ABSTRACT

A method for controlling the milking by a milking machine comprises the steps of: (i) providing (41) different milking schemes, each of which being distinguished by a set of milking parameters, such as milking vacuum, high pulse vacuum, low pulse vacuum, pulse rate, and pulse length; (ii) controlling (43) the milking machine for the milking of a milking animal so that each of the different milking schemes is applied for at least one milking of the milking animal; (iii) for each of the milkings, recording (45) milk yield and/or milking time of the milking of the animal; (iv) evaluating (51) each of the milking schemes for milking the animal based on the recorded milk yield and/or milking time; and (v) selecting (53) one of the milking schemes based on the evaluation, and controlling (53) the milking machine during subsequent milkings of the animal so that they are performed according to the selected milking scheme.

### TECHNICAL FIELD OF THE INVENTION

The present invention relates generally to dairy farming and to milking of dairy animals therein. Particularly, the invention relates to a method for controlling the milking by a milking machine, to a computer program product for carrying out the method when being run on a computer, and to an arrangement for controlling and monitoring the milking at a milking station.

### DESCRIPTION OF RELATED ART AND BACKGROUND OF THE INVENTION

In modern dairy farm industry there are continuous research and development activities in order to improve the efficiency of various activities such as machine milking, which, inter alia, involves increased milk yield and reduced milking time, while, naturally, ethical aspects as well as animal care are considered.

Machine milking, as known in the art, generally utilizes teat cups and vacuum sources to perform the milking function. In such systems each teat is contained within a teat cup having a teat receiving liner, inside the teat cup next to the teat. A working vacuum is applied to the interior of each teat cup liner to draw the milk from the teat, with the teat liners periodically opened and collapsed by applications of a pulsating massage vacuum between the liner and the inside of the cup. This periodic working of the teat liners results in the periodic flow of milk from each teat into a milk line, and constitutes the actual milking of the cow.

U.S. Pat. No. 4,011,838 by Nordegren et al. discloses a milking machine system including a flow rate sensing device, a timing device, and a system control means for varying the character of the working and pulsating massage vacuums during the milking process, in response to the rate of milk flow and to time. The milking machine system can be controlled in predetermined phases, such as a stimulation phase, a milking phase, a post-milking phase, and a switch-off phase, with the duration of the phases dependent on the rate of milk flow reaching certain predetermined levels and on time lapse parameters.

U.S. Pat. No. 5,054,425 by Grimm et al. discloses a method of milking an animal, wherein the conditions of the milking operation are substantially stable during a main milking phase and are unintentionally changed during a terminating milking phase. According to the invention, at least one unintentional change in the milking operation conditions during at least one initial milking operation is sensed, at least one milking parameter is registered in response to the sensed unintentional change, and each registered parameter is utilized to change the milking conditions of one or more following milking operations for the same animal before each sensed unintentional change is expected to occur. By the invention the milking may be changed during the post-milking phase to obtain an elimination of or at least a significant reduction of the rest milk in the udder of the animal.

European Patent No. 0954962 B1 discloses a method of automatically milking animals, comprising the following steps: measuring repeatedly or continuously a quantity which is a measure for the momentary pulse milk flow; controlling the duration and/or the level of the milk vacuum under the teat during the actual suction phase on the basis of the measured quantity; storage, during the actual suction phase, of the maximum value of the pulse milk flow measured thus far or the quantity related thereto; and lowering or reducing or closing off the vacuum level of the milk vacuum as soon as the momentary value of the pulse milk flow or the quantity related thereto has come below a specific, preferably adjustable threshold value.

European Patent No. 0679331 B1 discloses a method of automatically milking animals, such as cows. Use is made of teat cups, each of which is provided with a liner made of a flexible material, by means of which the teat space of a teat cup is separated from the pulsation space. During milking, a pulsating vacuum stimulating the milk yield is created in the pulsation space. When a teat cup is being connected to a teat, the pulsation space is kept at an approximately atmospheric pressure, while air is extracted from the teat space. Conversely, when a teat cup is being disconnected, in the pulsation space a vacuum is maintained and in the teat space the vacuum is neutralized.

European Patent No. 0403549 B1 discloses a milking apparatus comprising a teat cup with a liner, means for subjecting the interior of the liner to a pressure which is lower than atmospheric pressure, and for subjecting the pulsation chamber formed between the teat cup and the liner to a pulsating pressure varying between a low pressure and a high pressure, which is higher than the pressure in the interior of the liner. Means are provided for controlling the respective pressures in the liner and the pulsation chamber. A flow sensing member senses the flow of the milk which during milking increases to a main flow, then amounts to the main flow, and diminishes from the main flow in a terminating phase of milking. The pressure control means is adapted to control the various pressures in response to the flow sensing member sensing during the terminating milking phase that the milk flow has diminished to a predetermined portion of the main flow, such that the low pressure in the pulsation chamber is higher than the pressure in the liner, at least during a part of the terminating milking phase.

### SUMMARY OF THE INVENTION

While the above prior art references disclose different methods and milking schemes for improving the milking, they all fail to disclose how to obtain animal individual milking, which is optimized for each single milking animal.

It is therefore an object of the present invention to provide a method for controlling the milking by a milking machine, by which method the milking production is increased, and the animal treatment is improved.

It is a further object of the invention to provide such a method, which is accurate, efficient, reliable, of low cost, and easy to implement.

It is still a further object of the present invention to provide a computer program product for carrying out a method of the above-kind when being run on a computer.

It is yet a further object of the present invention to provide an arrangement to be used with a milking system, wherein the arrangement includes a process and control device capable of carrying out a method fulfilling the above-mentioned objects.

These objects, among others, are attained by the methods, the computer program product, and the arrangement as defined in the appended patent claims.

According to a first aspect of the invention there is provided a method for controlling the milking by a milking machine comprising the steps of: (i) providing a plurality of different milking schemes, each of which being distinguished by a set of milking parameters, such as milking vacuum, high pulse vacuum, low pulse vacuum, pulse rate, and pulse length; (ii) controlling the milking machine for the milking of a milking animal so that each of the different milking schemes is applied for at least one milking of the milking animal; (iii) for each of the milkings, recording a milk yield and/or a milking time of the milking of the milking animal; (iv) evaluating each of the milking schemes for milking the milking animal based on at least the recorded milk yield and/or the milking time; and (v) selecting one of the milking schemes based on the evaluation, and controlling the milking machine during subsequent milkings of the milking animal so that they are performed according to the selected one of the milking schemes.

Various embodiments are disclosed in the dependent claims.

By means of the present invention the overall milk production is optimized. The milk production can be maximized, while the animal care is maintained or even improved. Each milking animal is milked, after a test period, according to the most appropriate milking scheme. The selected milking scheme for each animal is chosen to maximize milk production, to maximize milk quality, to minimize milking time, to optimize the treatment of the animal, or a combination thereof. As compared to the use of a fixed constant milking scheme for all milking animals, the present invention provides for an individualized milking procedure which is optimized for each single milking animal.

Further characteristics of the invention and advantages thereof, will be evident from the detailed description of preferred embodiments of the present invention given hereinafter and the accompanying FIGS. 1-3, which are given by way of illustration only and thus, are not limitative of the present invention.

In the following detailed description the milk producing animals are cows. However, the invention is not limited to cows, but is applicable to any animals having the capability of producing milk, such as sheep, goats, buffaloes, horses, etc.

### BRIEF DESCRIPTION OF THE DRAWINGS

FIG. 1 illustrates schematically, in a perspective view, main components of a milking system, wherein a preferred embodiment of the present invention is implemented.

FIG. 2 is a flow scheme of a method for controlling the milking by the milking system of FIG. 1 according to an embodiment of the present invention.

FIG. 3 is an example diagram of milk flow as a function of milking time for the milking of a cow according to a particular milking scheme. The milking vacuum and the high pulse vacuum as functions of time in five different phases of milking are indicated.

### DETAILED DESCRIPTION OF EMBODIMENTS

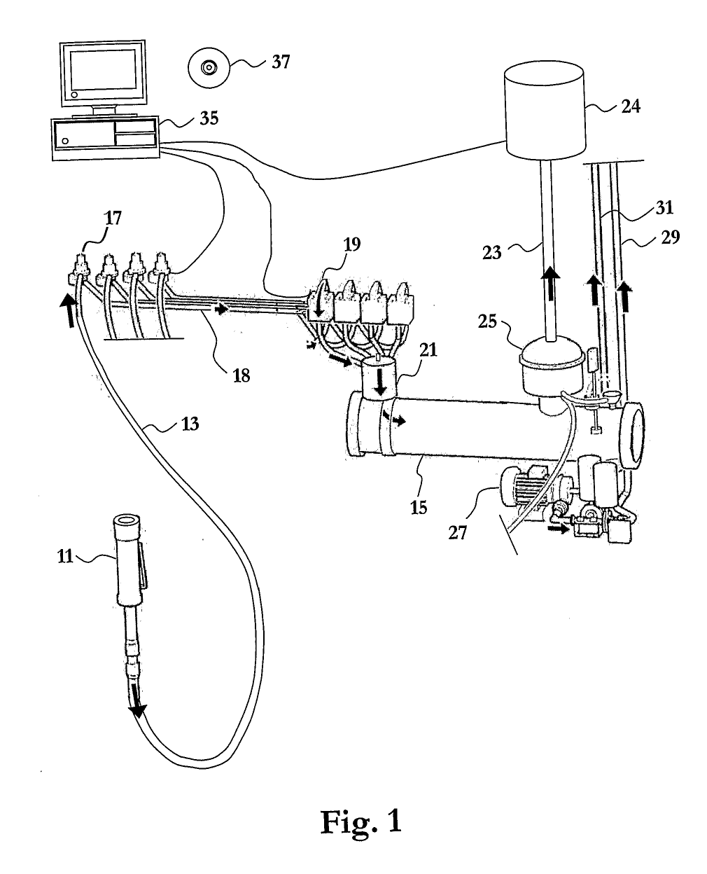

FIG. 1 illustrates some of the main components of an automated milking system for cows wherein the present invention is implemented. The automated milking system comprises a milking machine having four teat cups 11, of which only one is illustrated for sake of simplicity. Each teat cup 11 is connected to a respective milk tube 13, which in turn is connected to an end unit 15 via a respective valve or regulator 17, a respective milk conduit 18, a respective flow meter 19, optionally a respective conductivity meter or other measuring device such as an infrared spectrometer device (not shown), and a common milk meter 21. The end unit 15 is connected to a vacuum source 24 via a milk/air separator 25 and a vacuum supply conduit 23. The vacuum source 24 may be a vacuum pump of the rotary vane type, but is preferably a frequency controlled pump.

During milking of the teats of a cow, the teat cups are attached to the teats of a cow by a robot or manually, and vacuum is supplied to the end unit 15 via the vacuum supply conduit 23. The valves or regulators 17 may be used to vary the individual vacuum levels in the teat cups 11.

A working or milking vacuum is applied through the liner of each teat cup to draw the milk from the teats through the milk lines 13 and into the end unit 15, with the liners periodically opened and collapsed by applications of a pulsating massage vacuum between the liners and the inside of the teat cups. The milking vacuum is a stable vacuum that may be altered during the milking. The pulsating vacuum is altered between a high pulse vacuum and a low pulse vacuum (which often is atmospheric pressure), and is further characterized by a pulse rate or frequency as well as a pulse length. The pulse rate is the repetition rate of the vacuum pulses and the pulse length is the time of the application of the higher pulse vacuum. The pulsating vacuum parameters may also be altered during the progress of the milking.

The milk from each udder quarter of the cow is measured individually by the flow meters 19 and the conductivity meters 33, after which the weight of the milk from the cow is measured by the common milk meter 21. Finally, the milk is collected in the end unit 15 and the air is sucked out through the conduit 23.

Further, the milking machine comprises a pump and regulator system 27 for pumping the milk to a recipient, e.g. a milk storage tank, or to a milk truck (not illustrated) via one 29 of a plurality of milk output lines 29, 31 connected to the end unit. Another milk output line 31 may be used for discarding milk from the milking of a cow, for pumping the milk to another tank, or for pumping the milk to a feed device for feeding calves.

The milking machine is advantageously connected to a computer-based processing and control device 35, which is responsible for processing and controlling of the milking machine, and comprises typically a microcomputer, suitable software, and a database including information of each of the cows milked by the milking machine, such as e.g. when the respective cow was milked last time, when she was fed last time, her milk production, her health, etc.

Particularly, in connection with the present invention, the computer-based processing and control device 35 receives instantaneous milk flow measures from, and optionally controls, the flow meters 19, records milking times, and controls the vacuum source 24 and the valves or regulators 17 to obtain desired vacuum levels.

The present invention presents a novel method of cow-individually controlling milking parameters during milking. By milking parameters are here meant milking vacuum, high and low pulse vacuums, pulse rate or frequency and pulse length.

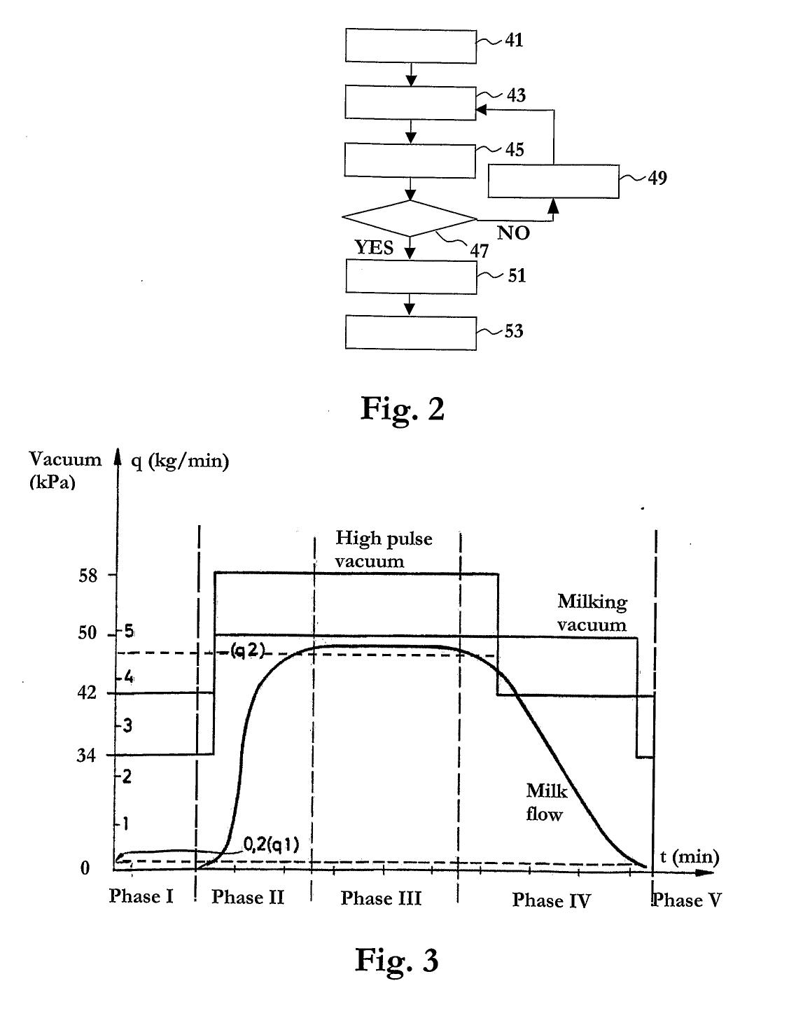

An embodiment of the invention will be outlined with reference to FIG. 2. A number of different milking schemes are, in a step 41, provided for the milking of a particular cow, and a first one of them is marked as the present milking scheme. The different milking schemes are each distinguished by a set of milking parameters. Examples of milking schemes to be applied herein have been described in the prior art section of this document. Other milking schemes that are possible to apply are found in a latter section of this description. The number of milking schemes provided may e.g. be between two and five.

The milking machine of the milking system of FIG. 1 is, in a step 43, while the particular cow is milked, controlled so that the milking is performed according to the present one of the different milking schemes. A milk yield and/or a milking time of the milking are, in step 45, recorded. It is then, in a step 47, checked whether the present milking scheme is the last milking scheme of the number of different milking schemes provided for the milking of the particular cow. If not, the method continues, in a step 49, by denoting a non-used milking scheme as the present milking scheme, after which the method is returned to step 43, i.e. the milking machine is controlled so that next milking of the particular cow is performed according to the now present milking scheme. A milk yield and/or a milking time of this milking are then, in the step 45, recorded, after which it is again checked, in the step 47, whether the present milking scheme is the last milking scheme.

The steps 43, 45, 47 form a loop, which is run until the particular cow has been milked according to each one of the number of different milking schemes, and corresponding milk yields and/or milking times have been recorded. At this stage, step 47 results in that it is confirmed that the present milking scheme is the last milking scheme of the number of different milking schemes.

The number of milkings, which may be performed as consecutive milkings, corresponds now to the number of the different milking schemes. The milking parameters of the milking systems are, during milking, controlled by adjusting the vacuum source 24 and/or the valves or regulators 17.

The method continues next to step 51. Here, an evaluation of each of the different milking schemes for milking the particular cow is performed based on at least the recorded milk yields and/or milking times. Finally, based on the evaluation, one of the different milking schemes is, in a step 53, selected, and the milking machine is controlled during subsequent milkings of the particular cow, so that they are performed according to the selected one of the different milking schemes.

The method is repeated for each cow that is to be milked by the milking system of FIG. 1.

By means of the present invention the overall milk production can be optimized. The milk production can be maximized, while the milking times are reduced, and good animal care is maintained. Each cow is treated individually in terms of applied milking schemes to obtain desired milk flows. As compared to the use of a fixed constant milking scheme for all cows, the present inventive cow individual adaptive application of different milking schemes provides for higher milk throughput since higher flows of milk and shorter milking times can be obtained.

It shall be appreciated that more accurate data may be obtained if the cows are milked more than once according to each milking scheme.

FIG. 3 is a schematic example diagram of milk flow as a function of milking time for the milking of a cow according to a particular milking scheme. The milking vacuum and the high pulse vacuum of the milking scheme as functions of time in five different phases of milking are indicated. The milking phases that can be distinguished include a teat cup application phase (phase I), a milk flow increasing or milk stimulation phase (phase II), a main phase (phase III), a milk flow decreasing or milk residue milking phase (phase IV), and a teat cup take off phase (phase V).

According to the illustrated milking scheme, the teat cups are applied while the milking vacuum is kept at about 34 kPa, and the high pulse vacuum is about 42 kPa. The low pulse vacuum is about 0 kPa, that is, atmospheric pressure. Note that the term vacuum as used herein is defined as “any pressure below atmospheric pressure, measured as the extent of the reduction in pressure below the ambient atmospheric pressure” as defined in ISO 3918 (1).

The pulse rate may be e.g. 1 Hz, whereas the pulse length may be e.g. 0.5 s during all five phases.

In the beginning of the milking during the phase II, the milking vacuum is kept at about 34 kPa, whereas the pulsating vacuum still varies between 0 kPa and 42 kPa. The high pulse vacuum ensures that the liners of the teat cups are opened completely during the pulsations, whereby the start-up of the milk flow through the teats is facilitated.

When the milk flow has increased to a relatively small value q1 of about 0.2 kg/min., which is indicated by the respective flow meters 19, the processing and control device 35 controls the vacuum source 24 and/or the valves or regulators 17, so that the milking vacuum is increased to about 50 kPa, while the high pulse vacuum is increased to about 58 kPa. The milking vacuum is still higher than the high pulse vacuum to ensure a complete opening of the liners during the pulsations. The milk flow increases rapidly in phase II to a rather constant flow q2.

Then, phase III of the milking ensues, during which the maximum flow prevails and the main part of the milk in the udder of the cow is extracted. During phase III the processing and control device 35 registers the size q2 of the main flow as measured by the respective flow meters 19.

After phase III of the milking, the fourth phase IV is reached, during which the milk flow decreases from the maximum flow. When the flow during phase IV has decreased to a predetermined part (e.g. 90%) of the maximum flow, the processing and control device 35 controls the vacuum source 24 and/or the valves or regulators 17 so that the high pulse vacuum is decreased to about 42 kPa, i.e. to a vacuum which is lower than the milking vacuum. Hereby the liners of the teat cups are not completely opened during the pulsations, whereby the friction engagement of the liners with the teats will be larger.

When the milk flow during phase IV has decreased to the relatively small value q1 of about 0.2 kg/min, the milking vacuum is decreased to about 34 kPa. By this the liners are completely opened during the pulsations, so that the rest of the milk easily can be milked out of the udder and the liners.

Finally, in phase V when the teat cups are taken off, the milking vacuum as well as the pulsating vacuum is switched off to ensure that no dirt is sucked into the teat cups when being released from the teats of the cow.

The above phases II-IV are similar to the phases I-III as described in the above mentioned European Patent No. 0403549 B1. The references cited in the prior art section describe some other of the different milking schemes to be used in the present invention, the contents of which references being hereby incorporated by reference.

Below, a few tables are found, each shortly describing a respective milking scheme. The phases I-V correspond to the phases described above.

TABLE 1
Milking scheme from U.S. Pat. No. 4,011,838.

| | Phase | Phase | Phase | Phase | Phase |
|---|---|---|---|---|---|
| | I | II | III | IV | V |
| Milking | — | 33 | 50 | 33 | 33 |
| vacuum (kPa) | | | | | |
| High pulse | — | 26 | 50 | 26 | 0 |
| vacuum (kPa) | | | | | |
| Low pulse | — | 0 | 0 | 0 | 0 |
| vacuum (kPa) | | | | | |
| Pulse rate (Hz) | — | 2.67 | 2 | 2.67 | No |
| Pulse length | — | 0.93 | 1.3 | 0.93 | No |
| (s) | | | | | |

TABLE 2
Milking scheme from EP 0403549 A1.

| | Phase | Phase | Phase | Phase | Phase |
|---|---|---|---|---|---|
| | I | II | III | IV | V |
| Milking | — | 34 and 50 | 50 | 50 and 34 | — |
| vacuum (kPa) | | (when q > 0.2 | | (when q < 0.2 | |
| | | kg/min) | | kg/min) | |
| High pulse | — | 42 and 58 | 58 | 58 and 42 | — |
| vacuum (kPa) | | (when q > 0.2 | | (when q < 90% of | |
| | | kg/min) | | main flow) | |
| Low pulse | — | 0 | 0 | 0 | — |
| vacuum (kPa) | | | | | |
| Pulse rate | — | 1 | 1 | 1 | — |
| (Hz) | | | | | |
| Pulse length | — | — | — | — | — |
| (s) | | | | | |

TABLE 3
Milking scheme Single vacuum level.

| | Phase | Phase | Phase | Phase | Phase |
|---|---|---|---|---|---|
| | I | II | III | IV | V |
| Milking | 42 | 42 | 42 | 42 | 0 |
| vacuum (kPa) | | | | | |
| High pulse | 42 | 42 | 42 | 42 | 0 |
| vacuum (kPa) | | | | | |
| Low pulse | 0 | 0 | 0 | 0 | 0 |
| vacuum (kPa) | | | | | |
| Pulse rate (Hz) | 1 | 1 | 1 | 1 | — |
| Pulse length | — | — | — | — | — |
| (s) | | | | | |

TABLE 4
Milking scheme Dual vacuum level.

| | Phase | Phase | Phase | Phase | Phase |
|---|---|---|---|---|---|
| | I | II | III | IV | V |
| Milking | 33 | 33 | 44 | 33 | 0 |
| vacuum (kPa) | | | | | |
| High pulse | 33 | 33 | 44 | 33 | 0 |
| vacuum (kPa) | | | | | |
| Low pulse | 0 | 0 | 0 | 0 | 0 |
| vacuum (kPa) | | | | | |
| Pulse rate (Hz) | 0.8 | 0.8 | 1 | 0.8 | — |
| Pulse length | 0.5 | 0.5 | 0.65 | 0.5 | — |
| (s) | | | | | |

TABLE 5
Milking scheme Modified dual vacuum level.

| | Phase | Phase | Phase | Phase | Phase |
|---|---|---|---|---|---|
| | I | II | III | IV | V |
| Milking | 33 | 33 | 44 | 44 firstly, | 0 |
| vacuum (kPa) | | | | then 33 | |
| High pulse | 33 | 33 | 50 | 33 | 0 |
| vacuum (kPa) | | | | | |
| Low pulse | 0 | 0 | 0 | 0 | 0 |
| vacuum (kPa) | | | | | |
| Pulse rate (Hz) | 0.8 | 0 | 1 | 1 firstly, | — |
| | | | | then 0.8 | |
| Pulse length | 0.5 | 0.5 | 0.65 | 0.65 firstly, | — |
| (s) | | | | then 0.5 | |

As can be seen some of the milking schemes have settings that are dependent on time lapsed whether other have settings that are altered depending on a milk flow from the cow fulfilling a predetermined criterion.

Further, the different milking schemes may be different in one of the milking phases, in two of the milking phases, in several of the milking phases, or in each of the milking phases. If the different milking schemes are different in one of the milking phases only, this single phase can be “isolated” and tested. For instance, the milking scheme Modified dual vacuum level may be provided in several versions wherein the only parameter that is varied is the milking vacuum in Phase III (the main milking phase). In this manner a single parameter can be tested independently of other parameters in a single milking phase. The term milking scheme as used in this description may thus refer to a sub portion of a milking such as a particular phase thereof.

In other instances, the milking phases may have different lengths in different milking schemes applied on different cows. One incentive is to minimize the total milking time for each cow, which is the sum of the times of the various phases.

The different milking schemes may be set fixed by a human user, or they may be modified and adjusted e.g. by a computer implemented machine learning method, preferably based on generic programming.

Different sets of milking schemes may be provided for each cow depending on previously used milking scheme for the cow, on the time elapsed since the cow was milked last, on where in the lactation period the cow is, on the milk yield per unit time of the cow, on the health of the cow, on the udder health of the cow, on the udder filling level of the cow, on whether the cow is giving suck to a suckling animal; on the pattern of behavior of the cow, on the activity of the cow, and/or on the feed consumption of the cow.

Particularly, if it is found, during an evaluation of milking schemes for a particular cow, that one milking scheme is to be used since it is better or much better than the other milking scheme(s) evaluated, next time milking schemes are to be evaluated for the cow (i.e. during the following test period), schemes more similar to the last used milking scheme may be tested and evaluated. A computer model based on a machine learning method may be used to gradually refine the milking schemes provided for a particular cow so that finally (after several test periods) the most favorable milking scheme will be evaluated and used for milkings of that cow. Since the optimum milking parameters for a cow may vary quite much with the condition, in which she is, at different times, the originally tested milking schemes may be tested yet again when a given time period has lapsed. Alternatively, other quite different milking schemes are tested. Then, the milking schemes are again gradually refined for each test period until a further given time period has lapsed.

The inventive method is preferably performed repeatedly, e.g. on a regular time basis, such as between about every fifth day and about every thirtieth day. The repetition frequency may be dependent on e.g. any of the milking scheme used for the cow, on where in the lactation period the cow is, on the milk yield of the cow, on the health of the cow, on the udder health of the cow, on whether the cow is giving suck to a suckling animal, on the pattern of behavior of the cow, on the activity of the cow, and/or on the feed consumption of the cow. Particularly, the method is performed more frequently in the beginning of a lactation period than in a later part thereof.

This far, it has not been discussed how the evaluation of the milking schemes is performed or how the selection of the milking scheme is made. There are several incentives to be met: the milk yield of the milking system should be as high as possible; the milking times should be as short as possible; the milk quality should be as good as possible; the animal should be treated in the best manner possible, etc. Thus, there are several solutions on how to evaluate and on how to select. Here below are found a few alternatives.

The evaluating step 51 of the method illustrated in FIG. 2 may comprise the step of finding the milking scheme of the different milking schemes, for which the particular cow gives the highest milk yield. Then, in step 53, the milking scheme, for which the particular cow gives the highest milk yield, is selected.

Alternatively, the evaluating step 51 of the method illustrated in FIG. 2 may comprise the step of finding the milking scheme of the different milking schemes, for which the particular cow gives the shortest milking time. Then, in step 53, the milking scheme, for which the particular cow gives the shortest milking time, is selected.

Yet alternatively, the recording step 45 of the method illustrated in FIG. 2 may comprise the step recording a quality of the milk from the milking of the particular cow. Then, in step 51, the milking scheme of the different milking schemes, for which the particular cow gives milk of the highest quality, is sought. Then, in step 53, the milking scheme, for which the particular cow gives milk of the highest quality, is selected.

Still alternatively, the recording step 45 of the method illustrated in FIG. 2 may comprise the step recording a health related parameter of the particular cow during the milking of the particular cow. Then, in step 51, the milking scheme of the different milking schemes, for which the particular cow has the best health related parameter is sought. Then, in step 53, the milking scheme, for which the particular cow has the best health related parameter, is selected.

It shall be appreciated that any evaluation and selection may be based upon a combination of the above approaches, optionally with different weights given to different factors.

The present invention has been verified experimentally. Cows were milked alternately using different milking schemes. Dual vacuum level and Modified dual vacuum level milking schemes according to Tables 4 and 5 were compared. It was found that some cows gave higher milk yield and shorter milking times using Dual vacuum level milking, whereas other cows gave higher milk yield and shorter milking times using Modified dual vacuum level milking.

While the present invention has been described as being implemented in a particular kind of automated milking system, it shall be understood that the same may alternatively be implemented in any other kind of milking system.

Thus, further improvements may be obtained by means of applying the present invention on a large number of cows. The milking machine is preferably controlled, while each of a large number of cows is milked a number of times, so that each of the milkings is performed according to a respective one of the different milking schemes. For each of the milkings of each of the cows, a milk yield and/or a milking time are recorded. Each of the milking schemes for milking each of the cows is evaluated based on at least the recorded milk yield and/or milking time, after which the cows are grouped into groups based on the evaluation.

Then, the milking machine is controlled during subsequent milkings of the cows so that subsequent milkings of cows that belong to the same group are performed according to the same milking scheme.

Alternatively, the milking machine is controlled during subsequent milkings of the cows so that subsequent milkings of cows that belong to the same group are performed according to milking schemes that cause these cows to have similar milking times.

In a dairy farm with several preferably automated milking stations each of the groups may have access to only one or a few of the milking stations. The groups may be formed based on the milking times and milk production of the cows so that the total milking time for milking all cows per day is dimensioned for the milking station or the few milking stations that the respective groups of cows have access to.

For a semi-automated milking system with batch-wise milking, such as a milking system in a Herringbone or parallel stall configuration serving a number of cows that is much higher than the number of milking places in the milking system, the groups are preferably formed so that cows belonging to the same group have similar milking times. The cows that belong to the same group are then milked simultaneously. Hereby, the throughput of cows through the milking system, and thereby the milking system, is optimized.

For a milking system in a rotary or carousel configuration, the groups are preferably formed so that cows belonging to the same group have similar milking times. The cows that belong to the same group are then milked at least partly simultaneously, i.e. cows within a single group enter the milking places of the rotary system consecutively. Hereby, the throughput of cows through the milking system is improved.

Alternatively, the cows are ranked in order of ascending or descending milking time, and the cows are entered into the rotary configured milking system according to their ranking order. The rotational speed of the system has to be sufficiently low so that the milking of the cow, which has the longest milking time, will be completed when the system has made one full revolution. By entering the cows in the ranked order, the system may be gradually rotated faster or slower depending on whether the cow, which first enters the rotary configuration, has the shortest or longest milking time. The throughput of cows through the milking system is hereby optimized.

Since the individual milk flows from each teat or udder quarter can be measured separately by the flow meters 19, and the individual vacuum levels in the teat cups 11 can be controlled separately via the valves or regulators 17, the inventive method may, in principle, be performed on a teat or udder quarter individual basis. Thus, for a given cow different milking schemes could be used for different teats or udder quarters.

Alternatively, the cows are grouped into groups based on an evaluation of the milk flow curves obtained during milking according to the different milking schemes. For instance, cows may be grouped together depending on the times to reach a steady milk flow. Cows that reach a steady milk flow very slowly may be milked simultaneously. They can be milked according to a particular milking scheme in a parlor and/or they can be massaged or stimulated manually before milking commences. Investigations have shown that cows react very positively on such treatments prior to milking.

The various methods of the present invention can be implemented as a computer program product, e.g. on a compact disc 37, which is loadable into the internal memory of the computer-based processing and control device 35 of the milking system as being illustrated in FIG. 1. The computer program product comprises software code portions for performing the various methods when the product is run on the computer-based processing and control device 35.

An arrangement comprising the computer-based processing and control device 35 is adapted to perform the various methods of the present invention. The computer-based processing and control device 35 controls the various milking parameters by means of controlling the vacuum source 24 and/or the valves or regulators 17.

1. A method for controlling the milking by a milking machine, characterized by the steps of:
providing plurality of different milking schemes, each of which being distinguished by a set of milking parameters, such as e.g. milking vacuum, high pulse vacuum, low pulse vacuum, pulse rate, and pulse length;
controlling said milking machine for the milking of a milking animal so that each of the different milking schemes is applied for at least one milking of the milking animal;
for each of the milkings, recording a milk yield and/or a milking time of the milking of said milking animal;
evaluating each of said different milking schemes for milking said milking animal based on at least said recorded milk yield and/or said milking time;
selecting one of said different milking schemes based on said evaluation; and
controlling said milking machine during subsequent milkings of said milking animal so that said subsequent milkings are performed according to said selected one of said different milking schemes.

2. The method of claim 1 wherein the steps of providing a plurality of different milking schemes, controlling said milking machine for the milking of a milking animal, recording a milk yield and/or a milking time, evaluating each of said different milking schemes, and selecting one of said different milking schemes are performed during a test
period, and the step of controlling said milking machine during subsequent milkings is performed during a milking period, said milking period being preferably longer than said test period.

3. The method of claim 1 wherein said plurality of different milking schemes is between two and five.

4. The method of claim 1 wherein each of said plurality of different milking schemes includes a milk flow increasing phase, a main phase, and a milk flow decreasing phase.

5. The method of claim 4 wherein each of said plurality of different milking schemes includes a teat cup application phase and a teat cup take off phase.

6. The method of claim 4 wherein said plurality of different milking schemes are different in at least one of the phases thereof.

7. The method of claim 4 wherein said plurality of different milking schemes is different in each of the phases thereof.

8. The method of claim 4 wherein at least one of the phases has different length in at least two of said plurality of different milking schemes.

9. The method of any claim 1 wherein said plurality of different milking schemes contains milking parameters which are dependent on time or on a milk flow from said milking animal.

10. The method of claim 1 wherein said plurality of different milking schemes is obtained from a human user of the milking machine.

11. The method of claim 1 wherein at least one of said plurality of different milking schemes is determined by a computer implemented machine learning method.

12. The method of claims 11 wherein the computer implemented machine learning method is based on generic programming.

13. The method of claim 1 wherein
said step of evaluating includes the step of finding the milking scheme of said different milking schemes, for which said milking animal gives the highest milk yield; and
said selected one of said different milking schemes is said milking scheme, for which said milking animal gives the highest milk yield.

14. The method of claim 1 wherein
said step of evaluating includes the step of finding the milking scheme of said different milking schemes, for which said milking animal gives the shortest milking time; and
said selected one of said different milking schemes is said milking scheme, for which said milking animal gives the shortest milking time.

15. The method of claim 1 wherein
a quality of the milk from the milking of said milking animal is recorded for each of said different milking schemes; and
said evaluation of each of said different milking schemes for milking said milking animal is based also on said recorded quality: of milk.

16. The method of claim 1 wherein
a health parameter of said milking animal is recorded during milking using each of said different milking schemes; and
said evaluation of each of said different milking schemes for milking said milking animal is based also on said recorded health parameter of said milking animal.

17. The method of claim 1 comprising the steps of:
controlling said milking machine for the milking of a plurality of milking animals so that each of said different milking schemes is applied for at least one milking of each of the plurality of milking animals;
for each of said milkings of each of said plurality of milking animals, recording a milk yield and/or a milking time;
evaluating each of said different milking schemes for milking each of said plurality of milking animals based on at least said recorded milk yield and/or said milking time; and
grouping said plurality of milking animals into groups based on said evaluation.

18. The method of claim 17 wherein said milking machine is controlled for subsequent milkings so that subsequent milkings of the milking animals that belong to the same group are performed according to the same milking scheme.

19. The method of claim 17 wherein said milking machine is controlled for subsequent milkings so that subsequent milkings of the milking animals that belong to the same group are performed according to milking schemes that cause the milking animals that belong to the same group to have similar milking times.

20. The method of claim 17 wherein said milking animals of said plurality of milking animals that belong to the same group are controlled to be milked simultaneously.

21. The method of claim 17 wherein said milking animals of said plurality of milking animals that belong to the same group are controlled to be milked consecutively, one after the other.

22. The method of claim 1 wherein said method is performed repeatedly.

23. The method of claim 22 wherein said method is repeated between about every fifth day and about every thirtieth day.

24. The method of claim 22 wherein said method is performed at a first frequency when said milking animal is in the beginning of the lactation, and at a second frequency when said milking animal is in a later part of the lactation, said first frequency being higher than said second frequency.

25. A computer program product loadable into the internal memory of a computer of a milking station, comprising software code portions for carrying out the method as claimed in claim 1 when said product is run on said computer.

26. An arrangement to be used at a milking station comprising a milking machine, said arrangement being adapted to carry out the method as claimed in claim 1.
